(19) United States
(12) Patent Application Publication
(10) Pub. No.: US 2026/0365836 A1
(43) Pub. Date: Nov. 19, 2026

(54) FLAME RETARDANT POLYPROPYLENE COMPOSITION

(71) Applicant: SABIC GLOBAL TECHNOLOGIES B.V., Bergen op Zoom (NL)

(72) Inventors: Ting HUANG, Shanghai (CN); Chaodong JIANG, Shanghai (CN); Hongtao SHI, Shanghai (CN); Christelle Marie Hélène GREIN, Aachen (DE)

(21) Appl. No.: 19/138,727

(22) PCT Filed: Dec. 11, 2023
(86) PCT No.: PCT/EP2023/085086

§ 371 Date: Jun. 13, 2025

(30) Foreign Application Priority Data
Dec. 13, 2022 (WO) PCT/CN2022/138682
Jan. 17, 2023 (EP) 23151927.3

(51) Int. Cl. C08L 23/12; C08J 3/20; C08K 3/22; C08K 5/52; C08K 5/523; C08K 13/02; H01B 3/44; H01B 7/295; H01B 13/14

(52) U.S. Cl. CPC C08L 23/12; C08J 3/201; C08K 13/02; H01B 3/441; H01B 7/295; H01B 13/14; C08J 2323/12; C08J 2423/08; C08J 2423/16; C08K 2003/2296; C08K 5/5205; C08K 5/523; C08K 2201/014; C08L 2201/02; C08L 2203/202; C08L 2205/025; C08L 2205/03; C08L 2207/02

(57) ABSTRACT

A composition including:
(A) a heterophasic propylene copolymer including a propylene-based matrix and a dispersed ethylene-α-olefin copolymer, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix,
(B) an ethylene-α-olefin copolymer having a density of at most 0.895 g/cm3;
(C) a flame retardant composition including at least one phosphate; and
(D) an aromatic phosphate ester.

### CROSS REFERENCE TO RELATED APPLICATIONS

This application is a National Stage Application of PCT/EP2023/085086, filed Dec. 11, 2023, which claims the benefit of Application No. PCT/CN2022/138682, filed Dec. 13, 2022 and European Application No. 23151927.3, filed Jan. 17, 2023, both of which are incorporated by reference in their entirety herein.

### BACKGROUND

The invention relates to a composition comprising a heterophasic propylene copolymer, to a process for obtaining such composition and an article comprising such composition, in particular an extruded article.

Plastic parts in an electric vehicle battery are preferred to be flame retardant. The plastic parts can be made by extrusion of a melt of a polymer composition. One of the important properties of the polymer composition is its processibility upon extrusion. The processibility of the composition can be understood by the degree of strain hardening of the composition. A good processibility is indicated by a high degree of strain hardening, which in turn is indicated by a large difference (ratio) between the tensile strength at break and the tensile strength at yield. A further important property of the polymer composition is the flame retardancy.

### SUMMARY

It is an object of the invention to provide a flame retardant composition which has an improved flame retardant property, preferably the composition has an improved processibility upon extrusion.

Accordingly, the present invention provides a composition comprising:
(A) a heterophasic propylene copolymer comprising a propylene-based matrix and a dispersed ethylene-α-olefin copolymer, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix,
(B) an ethylene-α-olefin copolymer having a density of at most 0.895 g/cm³;
(C) a flame retardant composition comprising at least one phosphate; and
(D) an aromatic phosphate ester.

### DETAILED DESCRIPTION

It was surprisingly found that the composition according to the invention has improved flame retardant properties and improved processibility upon extrusion.

In the context of the present invention “improved processibility upon extrusion” means that the ratio between the composition's tensile strength at break and tensile strength at yield is at least 1.17, wherein tensile strength at break and tensile strength at yield are measured according to ISO527-1:2019 using 1A specimen. “improved flame retardant properties” means a UL-94 rating of V-0 at 1 mm thickness. It is preferred that the composition has a UL-94 rating of V-0 at 0.8 mm thickness.

### (A) Heterophasic Propylene Copolymer

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers employed in the present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414; U.S. Pat. Nos. 4,399,054 and 4,472,524.

Preferably, the heterophasic propylene copolymer is made using Ziegler-Natta catalyst.

The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α-olefin copolymer.

These steps are preferably performed in different reactors. The catalyst systems for the first step and for the second step may be different or same.

The heterophasic propylene copolymer of the composition of the invention comprises a propylene-based matrix and a dispersed ethylene-α-olefin copolymer. The propylene-based matrix typically forms the continuous phase in the heterophasic propylene copolymer. The amounts of the propylene-based matrix and the dispersed ethylene-α-olefin copolymer may be determined by ¹³C-NMR, as well known in the art.

The propylene-based matrix consists of a propylene homopolymer and/or a propylene copolymer consisting of at least 90 wt % of propylene monomer units and at most 10 wt % of comonomer units selected from ethylene monomer units and α-olefin monomer units having 4 to 10 carbon atoms, for example consisting of at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexene, 1-heptene and 1-octene, and is preferably ethylene.

Preferably, the propylene-based matrix consists of a propylene homopolymer. The fact that the propylene-based matrix consists of a propylene homopolymer is advantageous in that a higher stiffness is obtained compared to the case where the propylene-based matrix is a propylene-α-olefin copolymer.

The melt flow index (MFI) of the propylene-based matrix (before the heterophasic propylene copolymer is mixed into the composition of the invention), MFI_{PP}, may be for example at least 0.1 dg/min, at least 0.2 dg/min, at least 0.3 dg/min, at least 0.5 dg/min, and/or for example at most 20 dg/min, at most 10 dg/min, at most 5.0 dg/min, at most 3.0 dg/min, at most 1.0 dg/min, measured according to ISO1133-1:2011 (2.16 kg/230 °C).

Preferably, the propylene-based matrix is present in an amount of 60 to 98 wt %, for example at most 97 wt %, at most 96 wt %, at most 95 wt %, at most 93 wt % or at most 91 wt %, based on the total heterophasic propylene copolymer. Preferably, the propylene-based matrix is present in an amount of at least 70 wt %, more preferably at least 75 wt %, for example at least 80 wt %, at least 85 wt %, at least 87 wt % or at least 90 wt %, based on the total heterophasic propylene copolymer.

The propylene-based matrix is preferably semi-crystalline, that is it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the invention, the degree of crystallinity of the propylene-based matrix is measured using differential scanning calorimetry (DSC) according to ISO11357-1 and ISO11357-3 of 1997, using a scan rate of 10 °C/min, a sample of 5 mg and the second heating curve using as a theoretical standard for a 100% crystalline material 207.1 J/g.

Besides the propylene-based matrix, the heterophasic propylene copolymer also comprises a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form. The particle size of the dispersed phase is typically in the range of 0.05 to 2.0 microns, as may be determined by transmission electron microscopy (TEM). The amount of the dispersed ethylene-α-olefin copolymer in the heterophasic propylene copolymer may herein be sometimes referred as RC.

Preferably, the amount of ethylene monomer units in the ethylene-α-olefin copolymer is 10 to 60 wt %, preferably 20 to 58 wt %, 30 to 55 wt % or 40 to 52 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexene, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

The MFI of the dispersed ethylene α-olefin copolymer (before the heterophasic propylene copolymer is mixed into the composition of the invention), MFI_{rubber}, may be for example at least 0.001 dg/min, at least 0.03 dg/min or at least 0.05 dg/min, and/or for example at most 0.1 dg/min or 0.01 dg/min. MFIrubber is calculated according to the following formula:

$$MFIrubber = {10}^{⋀} ( \frac{Log MFIheterophasic - matrix content ⋆ Log MFImatrix}{rubber content} )$$

wherein MFIheterophasic is the MFI (dg/min) of the heterophasic propylene copolymer measured according to ISO1133-1:2011 (2.16 kg/230 °C), MFImatrix is the MFI (dg/min) of the propylene-based matrix measured according to ISO1133-1:2011 (2.16 kg/230 °C), matrix content is the fraction of the propylene-based matrix in the heterophasic propylene copolymer, rubber content is the fraction of the dispersed ethylene-α-olefin copolymer in the heterophasic propylene copolymer. The sum of the matrix content and the rubber content is 1. For the avoidance of any doubt, Log in the formula means log₁₀.

Preferably, the dispersed ethylene-α-olefin copolymer is present in an amount of 2.0 to 40 wt %, for example at least 3.0 wt %, at least 4.0 wt %, at least 5.0 wt %, at least 7.0 wt % or at least 9.0 wt %, based on the total heterophasic propylene copolymer. Preferably, the dispersed ethylene-α-olefin copolymer is present in an amount of at most 30 wt %, more preferably at most 25 wt %, for example at most 20 wt %, at most 15 wt %, at most 13 wt % or at most 10 wt %, based on the total heterophasic propylene copolymer. This leads to good mechanical properties of the composition according to the invention such as impact strength.

In the heterophasic propylene copolymer in the composition of the invention, the sum of the total weight of the propylene-based matrix and the total weight of the dispersed ethylene-α-olefin copolymer may be at least 95 wt %, at least 97 wt %, at least 99 wt % or 100 wt % of the heterophasic propylene copolymer.

Preferably, the heterophasic propylene copolymer has a fraction soluble in p-xylene at 25 °C (CXS) measured according to ISO 16152:2005 of 2.0 to 40 wt %, for example 9.0 to 25 wt %.

Preferably, the amount of ethylene monomer units in the heterophasic propylene copolymer (sometimes referred as TC2) is in the range of 1.0 to 20 wt %, for example 5.0 to 15 wt %, based on the heterophasic propylene copolymer.

Preferably, the MFI of the heterophasic propylene copolymer is 1.0 to 20 g/10 min, for example 1.5 to 15 dg/min, 2.0 to 10 dg/min or 2.5 to 5.0 dg/min, measured according to ISO1133-1:2011 (230 °C/2.16 kg). This leads in particular to the good processibility of the composition according to the invention.

Preferably, in the heterophasic propylene copolymer according to the invention, the comonomer in the propylene-α-olefin copolymer is selected from ethylene and the group of α-olefins having 4 to 10 carbon atoms and the α-olefin in the ethylene-α-olefin copolymer is selected from the group of α-olefins having 3 to 8 carbon atoms. Most preferably, in the heterophasic propylene copolymer according to the invention, the comonomer in the propylene-α-olefin copolymer is ethylene and the α-olefin in the ethylene-α-olefin copolymer is propylene.

Preferably, the amount of (A) the heterophasic propylene copolymer with respect to the composition of the invention is 50 to 80 wt %, preferably 55 to 75 wt %.

### (B) Ethylene-α-Olefin Copolymer

The composition of the invention comprises (B) an ethylene-α-olefin copolymer having a density of at most 0.895 g/cm³. This results in the combination of a good processibility and a good flame retardancy of the composition.

Preferably, (B) the ethylene-α-olefin copolymer is a copolymer of ethylene and α-olefin comonomer having 4 to 10 carbon atoms, preferably 4 to 8 carbon atoms, more preferably is an acyclic monoolefin such as 1-butene, 1-pentene, 1-hexene, 1-octene, or 4-methyl-1-pentene. Most preferably, the ethylene-α-olefin copolymer is an ethylene-1-octene copolymer.

The ethylene-α-olefin copolymer (B) has a density of at most 0.895 g/cm³, preferably 0.850 to 0.895 g/cm³, more preferably 0.855 to 0.890 g/cm³, more preferably 0.860 to 0.880 g/cm³, more preferably 0.862 to 0.875 g/cm³, more preferably 0.864 to 0.870 g/cm³. The density may be measured according to ASTM D792.

The ethylene-α-olefin copolymer (B) may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomers may also be prepared using traditional types of heterogeneous multi-sited Ziegler-Natta catalysts.

Preferably, (B) the ethylene-α-olefin copolymer has a melt flow index min measured according to ASTM D1238 with a 2.16 kg load and at a temperature of 190 °C of 1.0 to 10 dg/min, preferably 2.0 to 8.0 dg/min, more preferably 3.0 to 7.0 dg/min. This leads to a combination of good mechanical properties and flame retardancy.

Preferably, the amount of (B) the ethylene-α-olefin copolymer with respect to the composition of the invention is 2.0 to 20 wt %, preferably 3.0 to 18 wt %.

In some preferred embodiments, the amount of (B) the ethylene-α-olefin copolymer with respect to the composition of the invention is 6.0 to 20 wt %, preferably 6.0 to 18 wt %. This leads to a particularly good processability.

In some preferred embodiments, the amount of (B) the ethylene-α-olefin copolymer with respect to the composition of the invention is 2.0 to 13 wt %, preferably 3.0 to 13 wt %. This leads to a combination of a good processability and a good flame retardancy.

Most preferably, the amount of (B) the ethylene-α-olefin copolymer with respect to the composition of the invention is 6.0 to 13 wt %. This leads to a combination of a particularly good processability and a good flame retardancy.

### (C) Flame Retardant Composition Comprising at Least One Phosphate

The flame retardant composition comprises at least one phosphate, wherein the phosphate is preferably selected from the group consisting of
melamine phosphate,
melamine polyphosphate,
melamine pyrophosphate,
piperazine phosphate,
piperazine polyphosphate,
piperazine pyrophosphate,
2-methylpiperazine monophosphate,
tricresyl phosphate,
alkyl phosphates,
haloalkyl phosphates,
tetraphenyl pyrophosphate,
poly(2-hydroxy propylene spirocyclic pentaerythritol bisphosphate),
poly(2,2-dimethylpropylene spirocyclic pentaerythritol bisphosphonate).

The flame retardant composition is preferably in the form of particles. Preferably the flame retardant composition has a normal particle size distribution (D50) of at least 8 microns as determined by Mastersizer 2000 available from Malvern.

Preferably, the amount of phosphate in the flame retardant composition is in the range from 40 to 75 wt % as measured after treating with nitric acid using ICP-OES spectrometer (iCAP 6300 Duo available from Thermo Fisher)

Preferably, the flame retardant composition comprises piperazine pyrophosphate, melamine phosphate and zinc oxide.

Preferably, the amount of piperazine pyrophosphate is in the range from 40 to 69 wt %, more preferably from 50 to 67 wt %; the amount of melamine phosphate is in the range from 29 to 49 wt % and the amount of zinc oxide is in the range from 1 to 10 wt %, based on the total amount of the flame retardant composition.

Preferably, the amount of (C) the flame retardant composition comprising at least one phosphate with respect to the composition of the invention is 10 to 30 wt %, preferably 15 to 25 wt %.

### (D) Aromatic Phosphate Ester

Preferably, the aromatic phosphate ester is selected from the group consisting of
resorcinol bis(diphenyl phosphate);
tetraphenyl resorcinol bis(diphenylphosphate);
bisphenol A bis(diphenyl phosphate);
bisphenol A diphosphate;
resorcinol bis(di-2,6-xylyl phosphate),
phosphoric acid, mixed esters with [1,1′-biphenyl]-4-4′-diol and phenol;
phosphorictrichloride, polymer with 1,3-benzenediol,phenylester;
1,3-phenylene-tetrakis(2,6-dimethylphenyl)diphosphate;
isopropenylphenyl diphenyl phosphate;
4-phenylphenolformaldehyde phenylphosphonate;
tris(2,6-xylyl) phosphate;
resorcinol bis(di-2,6-xylyl phosphate);
bisphenol S bis(diphenyl phosphate);
resorcinol-bisphenol A phenyl phosphates.

Preferably, the aromatic phosphate ester is added as a liquid in the process for making the composition according to the invention.

Preferably, the aromatic phosphate ester is bisphenol A bis(diphenyl phosphate).

Preferably, the amount of (D) the aromatic phosphate ester with respect to the composition of the invention is 0.1 to 10 wt %, preferably 1.0 to 5.0 wt %.

Preferably, the total of components (A), (B), (C) and (D) is at least 90 wt %, at least 95 wt %, at least 97 wt %, at least 98 wt %, at least 99 wt %, at least 99.5 wt %, at least 99.9 wt % or 100 wt % of the total composition.

### (E) Additives

The composition according to the invention may optionally comprise additives. The additives may include nucleating agents, stabilizers, e.g. heat stabilizers, anti-oxidants, UV stabilizers; colorants, like pigments and dyes; clarifiers; surface tension modifiers; lubricants; flame-retardants; mould-release agents; flow improving agents; plasticizers; anti-static agents; blowing agents.

The skilled person can readily select any suitable combination of additives and additive amounts without undue experimentation. The amount of the additives depends on their type and function and typically is of from 0 to about 10 wt %. The amount of the additives may e.g. be from about 0.1 to about 5 wt %; from about 1 to about 4 wt % or from 1.5 to about 3 wt % based on the total composition. The total amount of (A), (B), (C), (D) and (E) should add up to 100% by weight.

### Composition

Preferably, the composition has a melt flow index as measured according to ISO1133-1:2011 with a 2.16 kg load at 230 °C of 1.0 to 10 dg/min, preferably 1.5 to 5.0 dg/min.

Preferably, the composition has a UL94 rating of V-0 at 0.8 mm, wherein the UL94 measurement is performed on specimens which have been conditioned in a first environment of 70 °C, 50% RH for 168 hours, then conditioned in a second environment of 23 °C, 20% RH for 4 hours.

### Further Aspects

The composition of the invention may be obtained by a process comprising melt-mixing (A), (B), (C), (D) and optionally (E) by using any suitable means. Accordingly, the invention further relates to a process for the preparation of the composition according to the invention comprising melt mixing (A), (B), (C), (D) and optionally (E).

Preferably, the composition of the invention is made in a form that allows easy processing into a shaped article in a subsequent step, like in pellet or granular form. The composition can be a mixture of different particles or pellets; like a blend of (A), (B), (C), (D) and a masterbatch of additives. Preferably, the composition of the invention is in pellet or granular form as obtained by mixing all components in an apparatus like an extruder; the advantage being a composition with homogeneous and well-defined concentrations of the additives.

Melt-mixing may be done using techniques known to the skilled person, for example in an extruder. Generally, in the process of the invention, melt-mixing is performed at a temperature in the range of 200 to 260 °C.

Suitable conditions for melt-mixing, such as temperature, pressure, amount of shear, screw speed and screw design when an extruder is used are known to the skilled person.

The composition according to the invention may be processed by known processing methods, in particular extrusion.

The invention further relates to an article comprising the composition according to the invention, in particular an extruded article. Preferably, the article is a busbar or a cable for an electric vehicle battery. Preferably, the article is a cable for an electric vehicle battery comprising a conductor and an insulation layer, wherein the insulation layer comprises the composition according to the invention.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### EXPERIMENTS

### Materials

Heterophasic PP is a heterophasic propylene copolymer commercially available as 95MK40T from SABIC, having an MFI of 3.5 g/10 min as measured according to ISO1133:1-2011 at 230 °C, 2.16 kg. 95MK40T has a propylene homopolymer matrix and 21 wt % of dispersed ethylene-propylene copolymer and the total amount of moieties derived from ethylene in 95MK40T is 10.5 wt % as determined by NMR.

POE is an ethylene-1-octene copolymer commercially available from SABIC as FORTIFY™ elastomer C5070T, having an MFI of 5.0 dg/min as measured according to ASTM D1238 at 190 °C, 2.16 kg and a density of 0.868 g/cm³ as measured according to ASTM D792

LLDPE is an ethylene-1-butene copolymer commercially available from SABIC as LLDPE 218NT, having an MFI of 2.0 dg/min as measured according to ASTM D1238 at 190 °C, 2.16 kg and a density of 0.918 g/cm³ as measured according to ASTM D792

POP is an ethylene-1-octene copolymer commercially available from SABIC as COHERE™ 8102, having an MFI of 1.0 dg/min as measured according to ASTM D1238 at 190 °C, 2.16 kg and a density of 0.902 g/cm³ as measured according to ASTM D792

FP2500S is a flame retardant composition comprising at least one phosphate according to a preferred embodiment of the invention commercially available from Adeka as ADK STAB FP-2500S.

BPADP is Bisphenol-A Bis(Diphenyl Phosphate) commercially available from Daihachi.

Additive package: The additive package comprises 33 wt % stabilizer, 17 wt % anti-dipping agent (TSAN F449 from SABIC), 8 wt % slipping agent, 42 wt % color masterbatch. The weight percentage is based on the total amount of the additive package.

### Properties

Melt flow index (MFI) was measured according to ISO1133:1-2011 at 230 °C, 2.16 kg. Tensile properties were measured according to ISO527-1:2019 using 1A specimen. Density was measured according to ISO 1183-1:2004.

Charpy impact strength was measured according to ISO179/1eA at 23 °C (RT) and −20 °C.

Flame retardancy measurement was taken according to UL94. Specimens with different thicknesses were used, the specimens were conditioned prior to the measurement under the following condition:

After injection molding and prior to flame retardancy measurement, the specimens were conditioned in a first environment of 70 °C, 50% RH for 168 hours, then conditioned in a second environment of 23 °C, 20% RH for 4 hours.

Components shown in Table 1 were melt-mixed in a twin screw extruder to obtain pellets. The pellets were further injection molded into specimens for measurements of properties shown in Table 1.

TABLE 1

| | | CEx1 | Ex2 | Ex 3 | Ex 4 | CEx5 | CEx6 | CEx7 | CEx 8 | CEx 9 |
|---|---|---|---|---|---|---|---|---|---|---|
| Component | | | | | | | | | | |
| Heterophasic | wt % | 73.3 | 68.3 | 63.3 | 58.3 | 63.3 | 58.3 | 53.3 | 63.3 | 58.3 |
| PP | | | | | | | | | | |
| POE | wt % | | 5 | 10 | 15 | | | | | |
| LLDPE | wt % | | | | | 10 | 15 | 20 | | |
| POP | wt % | | | | | | | | 10 | 15 |
| FP2500S | wt % | 22 | 22 | 22 | 22 | 22 | 22 | 22 | 22 | 22 |
| BPADP | wt % | 3.5 | 3.5 | 3.5 | 3.5 | 3.5 | 3.5 | 3.5 | 3.5 | 3.5 |
| Additive | wt % | 1.2 | 1.2 | 1.2 | 1.2 | 1.2 | 1.2 | 1.2 | 1.2 | 1.2 |
| package | | | | | | | | | | |
| Properties | | | | | | | | | | |
| MFI | dg/min | 3.12 | 2.58 | 2.5 | 2.16 | 2.22 | 2.16 | 2.04 | 2.08 | 1.92 |
| Density | g/cm³ | 1.022 | 1.021 | 1.020 | 1.018 | 1.024 | 1.026 | 1.027 | 1.021 | 1.023 |
| Charpy @ RT | KJ/m² | 8.4 | 16.2 | 44.6 | 55.8 | 12.5 | 21.9 | 30.3 | 35.2 | 67 |
| Charpy @ −20 | KJ/m² | 1.7 | 2.6 | 2.6 | 3 | 1.7 | 2.3 | 2.4 | 2.4 | 2.5 |
| Tensile | MPa | 18.3 | 16.8 | 15.1 | 13.7 | 17.3 | 16.8 | 15.8 | 16.9 | 15.9 |
| strength @ | | | | | | | | | | |
| yield | | | | | | | | | | |
| Tensile | MPa | 18.9 | 19.9 | 19.4 | 18.2 | 17 | 16.7 | 16.2 | 18.3 | 18.6 |
| strength @ | | | | | | | | | | |
| break | | | | | | | | | | |
| Difference | MPa | 0.6 | 3.1 | 4.3 | 4.5 | −0.3 | −0.1 | 0.4 | 1.4 | 2.7 |
| TS@B-TS@Y | | | | | | | | | | |
| UL @ 0.8 mm | | V-2 | V-0 | V-0 | V-2 | V-2 | V-2 | V-2 | V-2 | V-2 |
| UL @ 1 mm | | V-0 | V-0 | V-0 | V-0 | V-0 | V-2 | V-2 | V-0 | V-0 |
| UL @ 1.2 mm | | V-0 | V-0 | V-0 | V-0 | V-0 | V-0 | V-0 | V-0 | V-0 |
| UL @ 1.5 mm | | V-0 | V-0 | V-0 | V-0 | V-0 | V-0 | V-0 | V-0 | V-0 |
| UL @ 2.0 mm | | V-0 | V-0 | V-0 | V-0 | V-0 | V-0 | V-0 | V-0 | V-0 |

A large difference between the tensile strength at break and the tensile strength at yield—namely the ratio between tensile strength at break and tensile strength at yield is at least 1.17—indicates a high degree of strain hardening, i.e. a improved processibility upon extrusion.

Ex 2 to Ex 4 which comprise a POE (ethylene-octene copolymer having a density at most 0.895 g/cm³) show a high degree of strain hardening. Ex 2 and 3 show the combination of a high degree of strain hardening and excellent flame retardancy. Ex 3 and 4 show a particularly high degree of strain hardening.

Comparing Ex 2-4 to each other, it can be understood that the higher amount of POE results in a lower MFI, a higher Charpy impact strength and a higher degree of strain hardening.

CEx 1 which does not comprise an ethylene copolymer (aside from part in the heterophasic propylene copolymer) as well as CEx 5 to CEx 9 which comprise an LLDPE or POP show a low degree of strain hardening and an unsatisfactory flame retardancy.

1. A composition comprising:
(A) a heterophasic propylene copolymer comprising a propylene-based matrix and a dispersed ethylene-α-olefin copolymer, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix,
(B) an ethylene-α-olefin copolymer having a density of at most 0.895 g/cm³;
(C) a flame retardant composition comprising at least one phosphate; and
(D) an aromatic phosphate ester.

2. The composition according to claim 1, wherein (A) has a melt flow index determined according to ISO1133-1:2011 at 2.16 kg and 230 °C of 1.0 to 10 dg/min.

3. The composition according to claim 1, wherein the density of (B) is 0.850 to 0.895 g/cm³.

4. The composition according to claim 1, wherein (B) has a melt flow index determined according to ISO1133-1:2011 at 2.16 kg and 190 °C of 1.0 to 10 dg/min.

5. The composition according to claim 1, wherein (B) is an ethylene-1-octene copolymer.

6. The composition according to claim 1, wherein (C) comprises piperazine pyrophosphate, melamine phosphate and zinc oxide.

7. The composition according to claim 1, wherein (D) is selected from the group consisting of
resorcinol bis(diphenyl phosphate);
tetraphenyl resorcinol bis(diphenylphosphate);
bisphenol A bis(diphenyl phosphate);
bisphenol A diphosphate;
resorcinol bis(di-2,6-xylyl phosphate),
phosphoric acid, mixed esters with [1,1′-biphenyl]-4-4′-diol and phenol;
phosphorictrichloride, polymer with 1,3-benzenediol,phenylester;
1,3-phenylene-tetrakis(2,6-dimethylphenyl)diphosphate;
isopropenylphenyl diphenyl phosphate;
4-phenylphenolformaldehyde phenylphosphonate;
tris(2,6-xylyl) phosphate;
resorcinol bis(di-2,6-xylyl phosphate);
bisphenol S bis(diphenyl phosphate); and
resorcinol-bisphenol A phenyl phosphates.

8. The composition according to claim 1, wherein the amount of (A) is 50 to 80 wt %, the amount of (B) is 2.0 to 20 wt %, the amount of (C) is 10 to 30 wt %, and/or the amount of (D) is 0.1 to 10 wt %, with respect to the total composition.

9. The composition according to claim 1, wherein the composition has a melt flow index determined according to ISO1133-1:2011 at 2.16 kg and 230 °C of 1.0 to 10 dg/min.

10. The composition according to claim 1, wherein the composition has a UL94 rating of V-0 at 0.8 mm, wherein the UL94 measurement is performed on specimens which have been conditioned in a first environment of 70 °C, 50% RH for 168 hours, then conditioned in a second environment of 23 °C, 20% RH for 4 hours.

11. The composition according to claim 1, wherein the amount of (B) is 6.0 to 20 wt %, with respect to the total composition.

12. The composition according to claim 1, wherein the amount of (B) is 2.0 to 13 wt %, with respect to the total composition.

13. A process for the preparation of the composition according to claim 1, comprising melt mixing components (A) to (D).

14. An article comprising the composition according to claim 1.

15. A method of making a busbar or a cable for an electric vehicle battery, the method comprising extruding the composition according to claim 1.
